(19) United States
(12) Patent Application Publication
(10) Pub. No.: US 2016/0094729 A1
(43) Pub. Date: Mar. 31, 2016

(54) IMAGE FORMING APPARATUS DEVELOPMENT SUPPORT SYSTEM

(71) Applicant: KYOCERA Document Solutions Inc., Osaka (JP)

(72) Inventor: Shin ISHIKAWA, Osaka-shi (JP)

(73) Assignee: KYOCERA Document Solutions Inc., Osaka (JP)

(21) Appl. No.: 14/869,662

(22) Filed: Sep. 29, 2015

(30) Foreign Application Priority Data
Sep. 30, 2014 (JP) 2014-201240

(51) Int. Cl. H04N 1/00; G06F 3/12

(52) U.S. Cl. CPC H04N 1/00204; H04N 1/0032; H04N 1/00639; G06F 3/1294; G06F 3/1284; H04N 1/00392; H04N 2201/0094

(57) ABSTRACT

An image forming apparatus in an image forming apparatus development support system includes an apparatus control section and an output section. Upon receiving virtual apparatus information from a development computer, the apparatus control section perceives the image forming apparatus as if an unattached optional device were attached to the image forming apparatus despite the fact that the unattached optional device is not attached. The apparatus control section then controls an apparatus storage section to store the virtual apparatus information as apparatus information indicating the current apparatus state. Upon receiving an instruction for outputting a report indicating the state of the image forming apparatus while the virtual apparatus information is stored in the apparatus storage section, the output section outputs the report based on the virtual apparatus information in accordance with a report outputting program.

### INCORPORATION BY REFERENCE

The present application claims priority under 35 U.S.C. §119 to Japanese Patent Application No. 2014-201240, filed on Sep. 30, 2014. The contents of this application are incorporated herein by reference in their entirety.

### BACKGROUND

The present disclosure relates to an image forming apparatus development support system including an image forming apparatus that is a development target to which an optional device is attachable.

A known image forming apparatus has a function of outputting a report indicating a state of the image forming apparatus (hereinafter, referred to as a report function). For example, an image forming apparatus causes an external device (for example, a personal computer) connected thereto to display the state of the image forming apparatus. Through the above, the external device can recognize the state of the image forming apparatus.

Image forming apparatuses include those to which optional devices are attachable. Examples of the optional devices attachable to the image forming apparatuses include a document conveyance device and a finishing device. The document conveyance device automatically conveys an original document to a document reading position. The finishing device performs finishing processing (punching processing and stapling processing) on paper after printing.

For example, upon an optional device being attached to the image forming apparatus, a control section of the image forming apparatus acquires information about the attached optional device from the optional device itself. The acquired information is stored in a storage section of the image forming apparatus. The image forming apparatus then receives an instruction to output a report while the optional device is attached thereto. In response, the image forming apparatus outputs a report containing the state of the image forming apparatus and the information about the optional device.

### SUMMARY

An image forming apparatus development support system of the present disclosure includes a development computer and an image forming apparatus that is a development target to which an optional device is attachable. The development computer includes a computer communication section. The computer communication section communicates with the image forming apparatus and transmits virtual apparatus information to the image forming apparatus. The virtual apparatus information indicates an apparatus state of the image forming apparatus perceived as if an unattached optional device that is not attached to the image forming apparatus were attached to the image forming apparatus. The image forming apparatus includes an apparatus storage section, an apparatus communication section, an apparatus control section, and an output section. The apparatus storage section stores therein apparatus information indicating an apparatus state of the image forming apparatus and a report outputting program for outputting a report indicating the apparatus state of the image forming apparatus. The apparatus communication section communicates with the development computer and receives the virtual apparatus information from the development computer. The apparatus control section perceives, upon the apparatus communication section receiving the virtual apparatus information, the image forming apparatus as if the unattached optional device were attached to the image forming apparatus and controls the apparatus storage section to store the virtual apparatus information as the apparatus information. The output section outputs the report based on the virtual apparatus information in accordance with the report outputting program upon receiving a report output instruction while the virtual apparatus information is stored in the apparatus storage section.

### BRIEF DESCRIPTION OF THE DRAWINGS

FIG. 1 is a schematic view of an image forming apparatus development support system according to an embodiment of the present disclosure.

FIG. 2 is a schematic view of an image forming apparatus included in the image forming apparatus development support system according to the embodiment of the present disclosure.

FIG. 3 is a block diagram illustrating hardware configuration of the image forming apparatus and a development computer included in the image forming apparatus development support system according to the embodiment of the present disclosure.

FIG. 4 is a diagram illustrating report outputting using the development computer that is performed in the image forming apparatus development support system according to the embodiment of the present disclosure.

FIG. 5 is a flowchart illustrating a process for report outputting using the development computer that is performed in the image forming apparatus development support system according to the embodiment of the present disclosure.

### DETAILED DESCRIPTION

### <Overview of Image Forming Apparatus Development Support System>

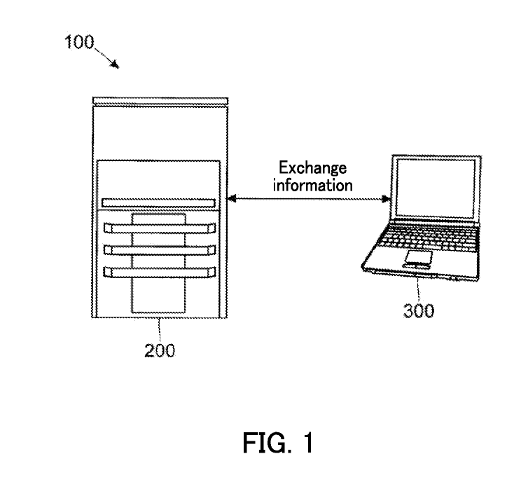

As illustrated in FIG. 1, an image forming apparatus development support system 100 of the present embodiment includes an image forming apparatus 200 that is a development target and a development computer 300. The image forming apparatus 200 is a multifunction peripheral having multiple functions such as a printing function and a copy function. The type of the image forming apparatus 200 is not particularly limited; the image forming apparatus 200 may be a printer or a facsimile machine.

The development computer 300 is a computer that is used by persons who perform development and maintenance of the image forming apparatus 200. The development computer 300 is for example a notebook personal computer, a desktop personal computer, or a tablet terminal.

The image forming apparatus 200 and the development computer 300 are connected with one another in a communicable manner and exchange various types of information. For example, the image forming apparatus 200 and the development computer 300 are connected with one another with a communication cable such as a USB cable to exchange information. Alternatively, the image forming apparatus 200 and the development computer 300 exchange information through near field communication.

### <Configuration of Image Forming Apparatus>

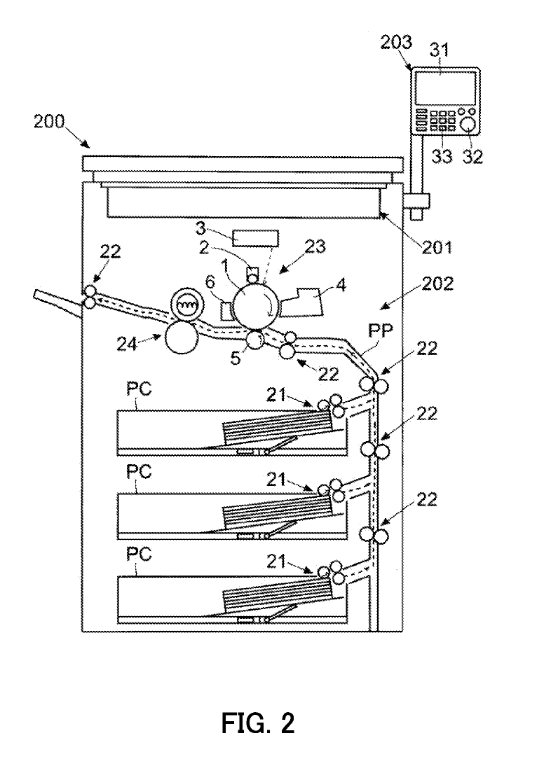

As illustrated in FIG. 2, the image forming apparatus 200 includes an image reading section 201, a printing section 202, and an operation panel 203. The printing section 202 and the operation panel 203 correspond to an “output section”. The operation panel 203 corresponds to an “apparatus display section”.

The image reading section 201 reads an image of an original document to generate image data corresponding to the image of the original document (hereinafter, the image data corresponding to the image of the original document may be referred to as original document image data). For example, various types of image processing is performed by the later-described apparatus control section 210 based on the original document image data obtained through reading by the image reading section 201. An image is printed by the printing section 202 based on the image data. Alternatively, data (such as facsimile data) to be transmitted to an external device is created based on the image data.

The printing section 202 includes paper feed sections 21, paper conveyance sections 22, an image forming section 23, and a fixing section 24. The paper feed sections 21 feed paper loaded in paper feed cassettes PC to a paper conveyance path PP. The paper conveyance sections 22 convey paper along the paper conveyance path PP. The image forming section 23 includes a photosensitive drum 1, a charger 2, a light exposure device 3, a developing device 4, a transfer roller 5, and a cleaning device 6. The image forming section 23 forms a toner image based on the image data and transfers the toner image onto paper. The fixing section 24 applies heat and pressure to the toner image transferred onto the paper to fix the toner image.

The operation panel 203 receives input of operation by a user. The operation panel 203 includes a display panel 31 equipped with a touch panel. The display panel 31 displays messages and soft keys for receiving various settings. The operation panel 203 further includes hard keys such as a start key 32 and a numeric keypad 33.

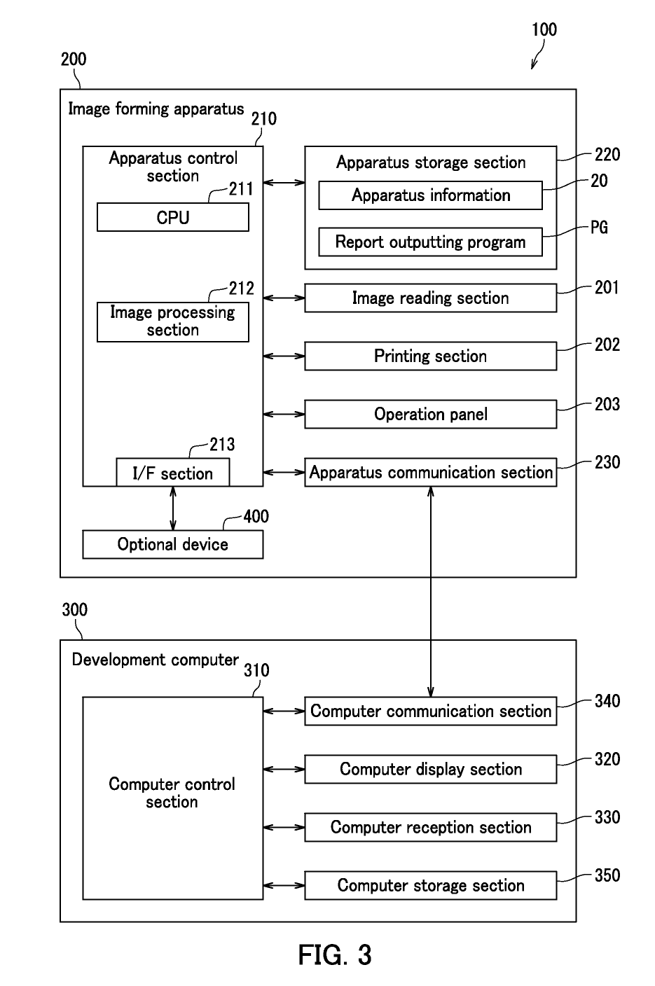

The image forming apparatus 200 further includes the apparatus control section 210 as illustrated in FIG. 3. The apparatus control section 210 includes a CPU 211 and an image processing section 212. The apparatus control section 210 is connected with an apparatus storage section 220. The apparatus storage section 220 stores therein a control program and control data. The CPU 211 controls operation of each section (the image reading section 201, the printing section 202, and the operation panel 203) of the image forming apparatus 200 according to the control program and the control data. The image processing section 212 includes an ASIC designed exclusively for image processing and performs image processing (scaling up/scaling down, density conversion, data format conversion, etc.) based on image data.

The apparatus storage section 220 includes ROM, RAM, and a HDD and so on. The control program and the control data are stored in the ROM or in the HDD and read into the RAM. In the present embodiment, the control program includes a report outputting program PG for outputting a report indicating the apparatus state of the image forming apparatus 200. The apparatus storage section 220 stores, as the control data, apparatus information 20 indicating the apparatus state of the image forming apparatus 200. The apparatus information 20 includes settings of the image forming apparatus 200. The settings of the image forming apparatus 200 are for example operation conditions of elements of the apparatus. The operation conditions of the elements include the rotational speed of a motor and temperature of a heater. The apparatus information 20 also includes information regarding the type and the specification of the image forming apparatus 200.

The apparatus control section 210 is connected with an apparatus communication section 230. Receiving an instruction from the apparatus control section 210, the apparatus communication section 230 communicates with the development computer 300. As a result, the image forming apparatus 200 can exchange various types of information with the development computer 300. In the present embodiment, the image forming apparatus 200 exchanges the apparatus information 20 (later-described virtual apparatus information 20A and actual apparatus information 20B) with the development computer 300.

At least one optional device 400 can be attached to the image forming apparatus 200. Examples of optional devices 400 that are attachable to the image forming apparatus 200 include a document conveyance device, an additional paper feed device, and a finishing device. The document conveyance device attached to the image forming apparatus 200 automatically conveys an original document to a document reading position in the image forming apparatus 200. The additional paper feed device attached to the image forming apparatus 200 (added to increase the paper feed stages) allows an increased amount of paper to be stored in the image forming apparatus 200. Alternatively or additionally, the additional paper feed device allows various types of paper having different sizes to be stored in one image forming apparatus. The finishing device attached to the image forming apparatus 200 enables finishing processing (punching processing, stapling processing, etc.) on paper printed in the image forming apparatus 200. Furthermore, a FAX board for facsimile communication, an SD card, and a solid state drive (SSD) may be attached to the image forming apparatus 200 as the optional device 400.

The apparatus control section 210 includes an I/F section 213. The apparatus control section 210 communicates, via the I/F section 213, with the optional device 400 connected to the I/F section 213 (the optional device 400 attached to the image forming apparatus 200). As a result, the apparatus control section 210 recognizes the optional device 400.

Upon recognizing attachment of the optional device 400 to the image forming apparatus 200, the apparatus control section 210 acquires optional device information from the optional device 400 through the communication via the I/F section 213. The optional device information is information about the optional device 400. The optional device information for example includes the type of the optional device 400, the specification of the optional device 400, and settings of the optional device 400 (specifically, operation conditions of elements of the device such as a motor and a sensor). Upon acquiring the optional device information from the optional device 400, the apparatus control section 210 overwrites the apparatus information 20. As a result, the image forming apparatus 200 is enabled to execute a job using the optional device 400.

### <Configuration of Development Computer>

As illustrated in FIG. 3, the development computer 300 includes a computer control section 310, a computer display section 320, a computer reception section 330, a computer communication section 340, and a computer storage section 350.

The computer control section 310 performs overall control of the development computer 300. The computer display section 320 displays various screens. The computer reception section 330 receives various input operations. For example, the computer control section 310 detects an input operation received by the computer reception section 330. The computer control section 310 causes the computer display section 320 to change screens being displayed based on a result of the detection.

The computer communication section 340 is connected with the apparatus communication section 230 (image forming apparatus 200) in a communicable manner. The computer communication section 340 exchanges various types of information with the image forming apparatus 200 under the control by the computer control section 310. The computer storage section 350 stores therein a program and data for controlling the development computer 300.

### <Report Function>

The image forming apparatus 200 has a report function. The report function is a function of outputting a report indicating the apparatus state of the image forming apparatus 200. In the present embodiment, the report is output in accordance with the report outputting program PG. The report is output by at least one of the printing section 202 and the operation panel 203. In a configuration in which the report is output by the printing section 202, the report is printed by the printing section 202. In a configuration in which the report is output by the operation panel 203, the report is displayed on the operation panel 203 (display panel 31). Hereinafter, the configuration in which the report is output by the printing section 202 will be described as an example.

The operation panel 203 receives a report output instruction. The report output instruction may be issued by the development computer 300 so long as the development computer 300 is connected with the image forming apparatus 200. Upon receiving the report output instruction, the apparatus control section 210 instructs the printing section 202 to print the report.

The printing section 202 prints the report based on the apparatus information 20 stored in the apparatus storage section 220. In other words, the content of the apparatus information 20 is printed in the report. Specifically, information such as the type of the image forming apparatus 200, the specification of the image forming apparatus 200, and the settings of the image forming apparatus 200 is printed in the report. When the optional device 400 is attached to the image forming apparatus 200, the report to be printed includes the optional device information in addition to the apparatus information.

### <Report Outputting Using Development Computer>

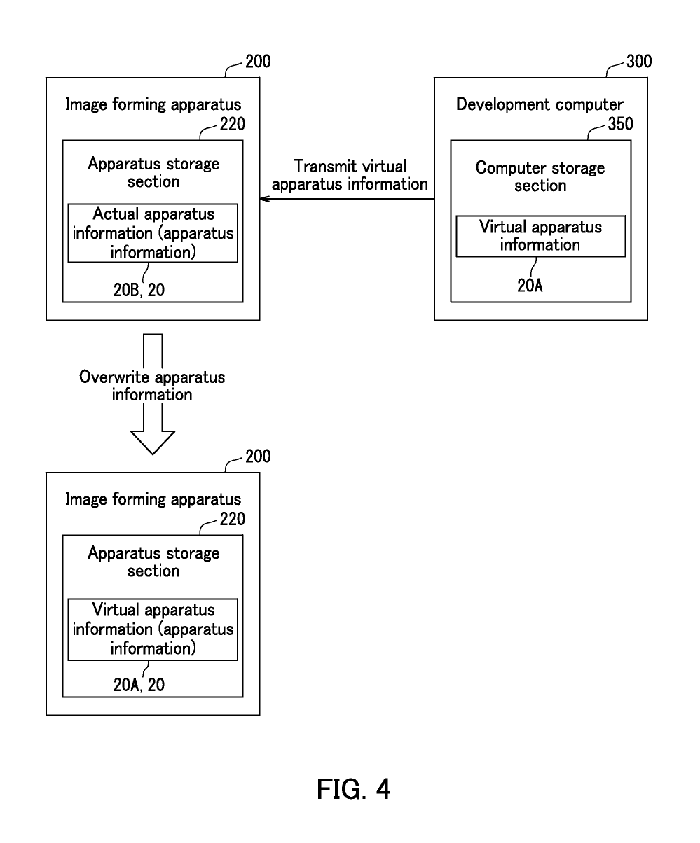

In the present embodiment, use of the development computer 300 allows outputting of a report on the image forming apparatus 200 perceived as if an optional device 400 that is not actually attached to the image forming apparatus 200 (hereinafter, may be referred to as an unattached optional device 400a) were attached. Hereinafter, detailed description will be provided with reference to FIGS. 3 and 4.

In the case of a report to be output using the development computer 300, the development computer 300 can receive settings of the image forming apparatus 200. The computer control section 310 controls the computer display section 320 to display a screen for receiving the settings of the image forming apparatus 200. The computer control section 310 also controls the computer reception section 330 to receive the settings of the image forming apparatus 200 perceived as if the unattached optional device 400a were attached. For example, the computer reception section 330 can receive the settings of the image forming apparatus 200 perceived as if three or more stages of additional paper feed devices were attached to the image forming apparatus 200 despite the fact that only two stages of additional paper feed devices are attached to the image forming apparatus 200. Upon the computer reception section 330 receiving the settings, the computer control section 310 generates the virtual apparatus information 20A and controls the computer storage section 350 to store the virtual apparatus information 20A (to retain the virtual apparatus information 20A). The virtual apparatus information 20A indicates the apparatus state of the image forming apparatus 200 perceived as if the unattached optional device 400a were attached thereto.

After the settings of the image forming apparatus 200 are made in the development computer 300, the computer control section 310 controls the computer reception section 330 to receive an instruction for transmitting the virtual apparatus information 20A. Upon the computer reception section 330 receiving the instruction for transmitting the virtual apparatus information 20A, the computer control section 310 instructs the computer communication section 340 to transmit the virtual apparatus information 20A to the image forming apparatus 200.

The virtual apparatus information 20A transmitted from the computer communication section 340 (development computer 300) is received by the apparatus communication section 230. Upon the apparatus communication section 230 receiving the virtual apparatus information 20A, the apparatus control section 210 perceives the image forming apparatus 200 as if the unattached optional device 400a were attached to the image forming apparatus 200 despite the fact that the unattached optional device 400a is not attached to the image forming apparatus 200. The apparatus control section 210 then controls the apparatus storage section 220 to store the virtual apparatus information 20A as the apparatus information 20 indicating the state of the image forming apparatus 200. In other words, the apparatus information 20 of the image forming apparatus 200 is changed from the actual apparatus information 20B (an actual apparatus state) to the virtual apparatus information 20A. The actual apparatus information 20B indicates an apparatus state of the image forming apparatus 200 to which the unattached optional device 400a is not attached. As a result of the change, the apparatus information 20 stored in the apparatus storage section 220 is information of the image forming apparatus 200 perceived as if the unattached optional device 400a were attached the image forming apparatus 200 despite the fact that the unattached optional device 400a is not attached to the image forming apparatus 200.

Thereafter, the apparatus control section 210 controls the operation panel 203 to receive a report output instruction. The report output instruction may be issued by the development computer 300. Upon the operation panel 203 receiving the report output instruction, the apparatus control section 210 controls the printing section 202 to print a report based on the virtual apparatus information 20A. Alternatively, the apparatus control section 210 controls the operation panel 203 to display the report based on the virtual apparatus information 20A. Since the report is output based on the virtual apparatus information 20A, the report contains information about the unattached optional device 400a. The report based on the virtual apparatus information 20A may be displayed in the development computer 300 (on the computer display section 320).

The virtual apparatus information 20A does not reflect the actual apparatus state of the image forming apparatus 200. After the report is output, therefore, overwriting needs to be performed to change the apparatus information 20 from the virtual apparatus information 20A to the actual apparatus information 20B. However, the overwriting of the apparatus information 20 is burdensome for a development person.

In order to reduce the burden, the computer control section 310 instructs the computer communication section 340 to acquire the actual apparatus information 20B from the image forming apparatus 200 prior to the transmission of the virtual apparatus information 20A from the development computer 300 to the image forming apparatus 200. The computer control section 310 then controls the computer storage section 350 to store the actual apparatus information 20B.

After the report based on the virtual apparatus information 20A is output, the apparatus control section 210 instructs the apparatus communication section 230 to acquire the actual apparatus information 20B from the development computer 300. Thereafter, the apparatus control section 210 changes the apparatus information 20 from the virtual apparatus information 20A to the actual apparatus information 20B. Thus, the apparatus information 20 is changed to information indicating the actual apparatus state of the image forming apparatus 200. That is, the apparatus information 20 returns to the information before the report is output.

The development person also needs to determine whether or not the report output from the image forming apparatus 200 contains all necessary pieces of information in debugging of the report outputting program PG for executing the report function. Accordingly, the burden on the development person is increased.

In order to reduce the burden, the apparatus control section 210 instructs the apparatus communication section 230 to transmit report information indicating pieces of information contained in the report to the computer communication section 340 (development computer 300) when the report based on the virtual apparatus information 20A is output from the image forming apparatus 200.

Upon the computer communication section 340 receiving the report information, the computer control section 310 determines whether or not the report contains all the pieces of information about the unattached optional device 400a (pieces of information that should be contained in the report) based on the report information. That is, the computer control section 310 determines whether or not the report has any missing piece of information from the information about the unattached optional device 400a. More specifically, the computer control section 310 determines whether or not the report has any missing information by comparing the virtual apparatus information 20A with the report information. When it is determined that the report has a missing piece of information, the computer control section 310 controls the computer display section 320 to display a notification message to notify that the report has a missing piece of information.

For example, the report may fail to contain a piece of information that indicates that four stages of paper feed devices are attached despite the fact that settings of the image forming apparatus 200 have been made in the development computer 300 so that four stages of paper feed devices are attached to the image forming apparatus 200. In this case, the computer display section 320 displays a message notifying that the information about the paper feed devices has not been output in the report normally. Alternatively, the computer display section 320 may display a specific missing piece of information.

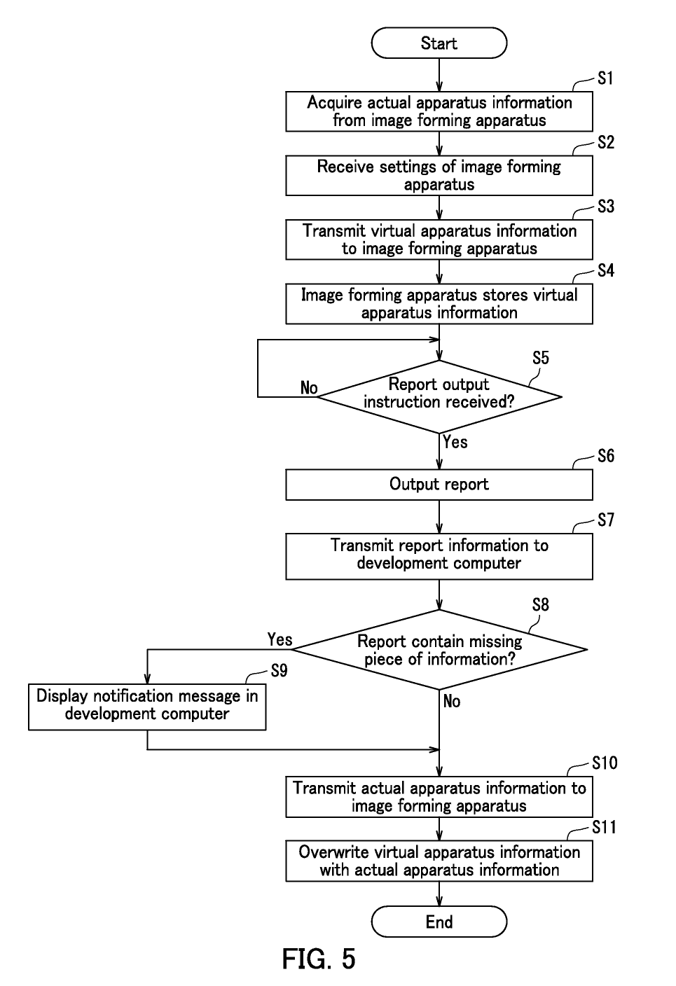

Hereinafter, a process for outputting a report using the development computer 300 will be described with reference to a flowchart shown in FIG. 5. The flowchart shown in FIG. 5 starts with a time when an operation for executing output of a report based on the virtual apparatus information 20A is performed on the development computer 300.

In step S1, the computer control section 310 instructs the computer communication section 340 to acquire the actual apparatus information 20B from the image forming apparatus 200. The acquired actual apparatus information 20B is stored in the computer storage section 350. In step S2, the computer control section 310 controls the computer reception section 330 to receive settings of the image forming apparatus 200 perceived as if the unattached optional device 400a were attached to the image forming apparatus 200. Once the settings of the image forming apparatus 200 have been made, the computer control section 310 instructs the computer communication section 340 to transmit the virtual apparatus information 20A to the image forming apparatus 200 in step S3.

In step S4, upon the apparatus communication section 230 receiving the virtual apparatus information 20A, the apparatus control section 210 perceives the image forming apparatus 200 as if the unattached optional device 400a were attached to the image forming apparatus 200. The apparatus control section 210 then controls the apparatus storage section 220 to store the virtual apparatus information 20A as the apparatus information 20 indicating the state of the image forming apparatus 200. In step S5, the apparatus control section 210 determines whether or not the operation panel 203 has received a report output instruction, or whether or not a report output instruction from the development computer 300 has been received. When it is determined that the report output instruction has been received, the process shifts to step S6. When it is determined that the report output instruction has not been received, the process repeats the determination in step S5.

Once the process shifts to step S6, the apparatus control section 210 instructs the printing section 202 to output (print) the report. Alternatively, the apparatus control section 210 instructs the operation panel 203 to output (display) the report. In step S7, the apparatus control section 210 instructs the apparatus communication section 230 to transmit report information indicating pieces of information contained in the report to the development computer 300.

In step S8, the computer control section 310 determines whether or not the report has a missing piece of information based on the report information. When it is determined that the report has a missing piece of information (that the report fails to contain the information about the unattached optional device 400a), the process shifts to step S9, and the computer control section 310 controls the computer display section 320 to display a notification message to notify that the report has a missing piece of information. The process then shifts to step S10. When the computer control section 310 determines that the report does not have any missing information (that the report contains the information about the unattached optional device 400a) in step S8, the process shifts to step S10.

Once the process shifts to step S10, the computer control section 310 instructs the computer communication section 340 to transmit the actual apparatus information 20B to the image forming apparatus 200. In step S11, upon the apparatus communication section 230 receiving the actual apparatus information 20B, the apparatus control section 210 overwrites the virtual apparatus information 20A stored in the apparatus storage section 220 with the actual apparatus information 20B.

As described above, the image forming apparatus development support system 100 of the present embodiment includes the development computer 300 and the image forming apparatus 200 that is a development target to which the optional device 400 is attachable. The development computer 300 includes the computer communication section 340. The computer communication section 340 communicates with the image forming apparatus 200 and transmits to the image forming apparatus 200 the virtual apparatus information 20A indicating the apparatus state of the image forming apparatus 200 perceived as if the unattached optional device 400a, which is not actually attached to the image forming apparatus 200, were attached to the image forming apparatus 200. The image forming apparatus 200 includes the apparatus storage section 220, the apparatus communication section 230, the apparatus control section 210, and the printing section 202. The apparatus storage section 220 stores the apparatus information 20 indicating the apparatus state of the image forming apparatus 200. The apparatus communication section 230 communicates with the development computer 300 to receive the virtual apparatus information 20A from the development computer 300. Upon the apparatus communication section 230 receiving the virtual apparatus information 20A, the apparatus control section 210 perceives the image forming apparatus 200 as if the unattached optional device 400a were attached to the image forming apparatus 200 and controls the apparatus storage section 220 to store the virtual apparatus information 20A as the apparatus information 20 indicating the apparatus state of the image forming apparatus 200. Upon receiving a report output instruction while the virtual apparatus information 20A is stored in the apparatus storage section 220, the printing section 202 outputs the report based on the virtual apparatus information 20A in accordance with the report outputting program PG.

According to the configuration of the present embodiment, it is possible to change the apparatus information 20 indicating the apparatus state of the image forming apparatus 200 to the information indicating the apparatus state of the image forming apparatus 200 perceived as if the unattached optional device 400a were attached thereto only by transmitting the virtual apparatus information 20A from the development computer 300 to the image forming apparatus 200. Upon the image forming apparatus 200 receiving a report output instruction while the virtual apparatus information 20A is stored in the apparatus storage section 220, a report based on the virtual apparatus information 20A is output. That is, a report is output based on the apparatus information 20 indicating the apparatus state of the image forming apparatus 200 perceived as if the unattached optional device 400a were attached thereto. It is therefore unnecessary to actually attach the unattached optional device 400a to the image forming apparatus 200 to obtain a report that would be output if the unattached optional device 400a were to be attached to the image forming apparatus 200.

If the report outputting program PG for executing the report function has a bug, it is impossible to output a report normally. For example, the report may fail to contain information about the optional device 400 despite the fact that the optional device 400 is attached to the image forming apparatus 200. Commonly, therefore, debugging of the report outputting program PG for executing the report function is performed in a stage of development of the image forming apparatus 200.

In order to perform the debugging of the report outputting program PG accurately, a development person needs to check the report that is output while the optional device 400 is attached to the image forming apparatus 200. That is, in a situation in which there is an unattached optional device 400a that is not attached to the image forming apparatus 200, the development person needs to prepare and attach the unattached optional device 400a to the image forming apparatus 200.

However, there are a number of optional devices 400 that are attachable to the image forming apparatus 200. Accordingly, it is time-consuming and requires a high development workload to prepare all the optional devices 400 that are attachable to the image forming apparatus 200 and obtain every report based on the apparatus state of the image forming apparatus 200 to which each of the optional devices 400 is attached.

However, according to the present embodiment, for example, preparation of the unattached optional device 400a and attachment of the unattached optional device 400a to the image forming apparatus 200 for the debugging of the report outputting program PG can be omitted. Thus, development workload can be reduced and convenience to the development person can be increased.

In the present embodiment, as described above, the apparatus storage section 220 stores the actual apparatus information 20B indicating the actual apparatus state of the image forming apparatus 200 as the apparatus state before the apparatus communication section 230 receives the virtual apparatus information 20A. Furthermore, the computer communication section 340 acquires the actual apparatus information 20B from the apparatus storage section 220 of the image forming apparatus 200 before the image forming apparatus 200 transmits the virtual apparatus information 20A. After the report based on the virtual apparatus information 20A is output, the computer communication section 340 transmits the actual apparatus information 20B to the image forming apparatus 200. Upon the apparatus communication section 230 receiving the actual apparatus information 20B, the apparatus control section 210 overwrites the virtual apparatus information 20A stored in the apparatus storage section 220 with the actual apparatus information 20B.

According to the above-described configuration, it is not necessary for the development person to change the apparatus information 20 from the virtual apparatus information 20A to the actual apparatus information 20B after the report based on the virtual apparatus information 20A is output in, for example, debugging of the report outputting program PG. Thus, convenience to the development person who performs the debugging of the report outputting program PG is increased. Furthermore, it is possible to prevent the virtual apparatus information 20A, which does not reflect the actual apparatus state of the image forming apparatus 200, from being left stored in the apparatus storage section 220.

In the present embodiment, as described above, the development computer 300 further includes the computer display section 320 and the computer control section 310. The computer display section 320 displays information. The computer control section 310 controls displaying by the computer display section 320. The apparatus control section 210 instructs the apparatus communication section 230 to transmit to the computer communication section 340 (development computer 300) the report information indicating the pieces of information contained in the report. The computer control section 310 determines whether or not the report has a missing piece of information from the pieces of information about the unattached optional device 400a based on the report information received by the computer communication section 340. Upon determining that the report has a missing piece of information, the computer control section 310 controls the computer display section 320 to display a message to notify that the report has a missing piece of information.

According to the configuration, whether or not the content of the output report is normal can be determined easily in, for example, debugging of a program for the report function. Thus, convenience to the development person who performs the debugging of the program for the report function is increased.

Note that all matter described in the embodiment disclosed herein is in no way limiting and should be considered to merely illustrate an example. The scope of the present disclosure is defined not by the above embodiment but by the Claims. Furthermore, any modifications within the scope of the Claims or equivalent in meaning thereto are also included in the scope of the present disclosure.

What is claimed is:

1. An image forming apparatus development support system comprising:
a development computer; and
an image forming apparatus that is a development target to which an optional device is attachable, wherein
the development computer includes
a computer communication section configured to communicate with the image forming apparatus and transmit virtual apparatus information to the image forming apparatus, the virtual apparatus information indicating an apparatus state of the image forming apparatus perceived as if an unattached optional device that is not attached to the image forming apparatus were attached to the image forming apparatus, and
the image forming apparatus includes:
an apparatus storage section configured to store therein apparatus information indicating an apparatus state of the image forming apparatus and a report outputting program for outputting a report indicating the apparatus state of the image forming apparatus;
an apparatus communication section configured to communicate with the development computer and receive the virtual apparatus information from the development computer;
an apparatus control section configured to perceive, upon the apparatus communication section receiving the virtual apparatus information, the image forming apparatus as if the unattached optional device were attached to the image forming apparatus and control the apparatus storage section to store the virtual apparatus information as the apparatus information; and
an output section configured to output the report based on the virtual apparatus information in accordance with the report outputting program upon receiving a report output instruction while the virtual apparatus information is stored in the apparatus storage section.

2. The image forming apparatus development support system according to claim 1, wherein
the apparatus storage section stores actual apparatus information indicating an actual apparatus state of the image forming apparatus as the apparatus state before the apparatus communication section receives the virtual apparatus information,
the computer communication section
acquires the actual apparatus information from the apparatus storage section before transmitting the virtual apparatus information to the image forming apparatus and
transmits the actual apparatus information to the image forming apparatus after the report based on the virtual apparatus information is output, and
upon the apparatus communication section receiving the actual apparatus information, the apparatus control section overwrites the virtual apparatus information stored in the apparatus storage section with the actual apparatus information.

3. The image forming apparatus development support system according to claim 1, wherein
the development computer further includes
a computer display section configured to display information and
a computer control section configured to control displaying by the computer display section,
the apparatus control section instructs the apparatus communication section to transmit report information to the computer communication section, the report information indicating pieces of information contained in the report, and
the computer control section
determines whether or not the report has a missing piece of information from pieces of information about the unattached optional device based on the report information received by the computer communication section and
upon determining that the report has a missing piece of information, controls the computer display section to display a message to notify that the report has a missing piece of information.

4. The image forming apparatus development support system according to claim 1, wherein
the output section includes a printing section configured to print an image, and
the printing section prints the report.

5. The image forming apparatus development support system according to claim 1, wherein
the output section includes an apparatus display section configured to display information, and
the apparatus display section displays the report.
